(19) United States
(12) Patent Application Publication
(10) Pub. No.: US 2009/0216449 A1
(43) Pub. Date: Aug. 27, 2009

(54) Passive Mapping Using a Floor Cleaning Machine

(76) Inventors: Robert J. Erko, Apple Valley, MN (US); Eric C. Li, Minneapolis, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 12/364,148

(22) Filed: Feb. 2, 2009

Related U.S. Application Data
(60) Provisional application No. 61/025,413, filed on Feb. 1, 2008.

(51) Int. Cl. G06F 17/00

(52) U.S. Cl. 701/300

(57) ABSTRACT

A floor cleaning machine having a passive mapping system for determining position information associated with a plurality of RFID tags dispersed within a floor field during a floor cleaning process. The passive mapping system defines a floor map based on position information collected from the plurality of RFID tags. The floor map may be communicated to a remote map server and be utilized by a second floor cleaning machine during a different floor cleaning process. The mapping system can periodically update the floor map based on information collected during subsequent floor cleaning processes. The information may include RFID tag movement or replacement. In one embodiment, a remote mapping system communicates with a floor cleaning machine via wireless communication.

### RELATED APPLICATIONS

This application claims the benefit of priority of U.S. Ser. No. 61/025,413, filed Feb. 1, 2008, which is hereby incorporated by reference in its entirety.

### TECHNICAL FIELD

The present invention relates generally to improved techniques for creation of maps used, for example, in subsequent object localization. More particularly, the invention relates to techniques and devices for mapping based on signals received from radio frequency tags dispersed throughout a region within which a location of a portable machine is to be determined, particularly while performing an unrelated primary function of a floor cleaning machine.

### BACKGROUND OF THE INVENTION

Radio frequency identification (RFID) systems have been employed in an ever increasing range of applications. For example, RFID systems have been used in supply chain management applications to identify and track merchandise throughout manufacture, warehouse storage, transportation, distribution, and retail sale. RFID systems have also been used in security applications to identify and track personnel for controlling access to restricted areas of buildings and plant facilities, thereby prohibiting access to such areas by individuals without the required authorization. Accordingly, RFID systems have been increasingly employed in diverse applications to facilitate the identification and tracking of merchandise, personnel, and other items and/or individuals that need to be reliably monitored and/or controlled within a particular environment.

A conventional RFID system typically includes at least one RFID transponder or tag, at least one RFID reader, and at least one controller or host computer. For example, in a manufacturing environment, RFID tags can be attached to selected items of manufacture or equipment, and at least one RFID reader can be deployed in the environment to interrogate the tags as the tagged items pass predefined points on the manufacturing floor. In a typical mode of operation, the reader transmits a radio frequency (RF) signal in the direction of a tag, which responds to the transmitted RF signal with another RF signal containing information identifying the item to which the tag is attached, and possibly other data acquired during the manufacture of the item.

Whether implemented as computer peripherals or networked devices, conventional RFID readers generally collect data from RFID tags much like optical barcode readers collect data from barcode labels. However, whereas an optical barcode reader typically requires a direct line of sight to a barcode label to read the data imprinted on the label, the RF signals employed by the typical RFID reader can penetrate through objects obstructing an RFID tag from the RF field of view of the reader, thereby allowing the reader to access data from a tag that, for example, might be covered. In addition, unlike the optical barcode reader, the conventional RFID reader can operate on and distinguish between multiple RFID tags within the field of the reader.

### BRIEF SUMMARY OF THE INVENTION

A system of passive mapping for location identification employs a set of RFID tags dispersed throughout a floor or other region. Passive map generation utilizing a portable machine receives and processes signals received from tags in the vicinity of the machine. Signals from multiple tags can be employed in determining a location. The tags may be mapped to their locations by moving a portable machine through the building, suitably during operation of the portable machine to perform a desired routine task, such as sweeping, scrubbing, etc. A mapping engine acquires signals or related information from the dispersed tags and associates signals or information within the facility in which the tag is located. The mapping information obtained by this process can be stored in a location server associated with the portable machine, facility or within a network or communicated elsewhere. Depending on the particular RFID tags employed, the mapping may be accomplished by associating locations with specific codes or by associating locations with possible paths that may be used to reach the locations.

The present invention relates to a floor cleaning machine and passive mapping system for determining position information associated with a plurality of RFID tags dispersed within a floor field during a floor cleaning process. A passive mapping system defines a floor map based on position information collected from the plurality of RFID tags. The floor map may be communicated to a remote map server and be utilized by a second floor cleaning machine during a different floor cleaning process. The mapping system can periodically update the floor map based on information collected during subsequent floor cleaning processes. The information may include RFID tag movement or replacement. In one embodiment, a remote mapping system communicates with a floor cleaning machine via wireless communication.

According to an embodiment of the present invention, a computer-implemented method for creating maps for subsequent object localization comprises providing a plurality of tags having fixed positions within an environment and a defined identification structure, and providing a reader upon a portable machine, for detecting the tags and reading the identifications, wherein the reader detects a plurality of tags within a scanning volume during operation of the portable machine.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a perspective view a floor cleaning machine traversing a floor field having a plurality of RFID tags incorporated within a plurality of floor tiles in accordance to the present invention.

FIG. 2 illustrates one embodiment of a mapping process in accordance with the present invention.

### DETAILED DESCRIPTION OF THE INVENTION

Significant customer value can be derived if a cleaning machine's location and operating parameters can be accurately determined and stored within a building or other site. An embodiment of the present invention provides a system for creating a usable facility map utilizing a portable machine as a passive mapping tool. In a preferred embodiment, the portable machine performs a routine cleaning function.

By way of background, in the conventional RFID system, each RFID tag typically includes a small antenna operatively connected to a microchip. For example, in the UHF band, the tag antenna can be just several inches long and can be implemented with conductive ink or etched in thin metal foil on a substrate of the microchip. Further, each tag can be an active tag powered by a durable power source such as an internal battery, or a passive tag powered by inductive coupling, receiving induced power from RF signals transmitted by an RFID reader. For example, an RFID reader may transmit a continuous unmodulated RF signal (i.e., a continuous wave, CW) or carrier signal for a predetermined minimum period of time to power a passive tag. The volume of space within which a reader can deliver adequate power to a passive tag is known as the power coupling zone of the reader. The internal battery of active tags may be employed to power integrated environmental sensors, and to maintain data and state information dynamically in an embedded memory of the tag. Because passive tags do not have a durable power source, they do not include active semiconductor circuitry and must therefore maintain data and state information statically within its embedded memory.

The RFID reader typically follows a predefined sequence or protocol to interrogate and retrieve data from one or more RFID tags within the RF field of the reader (also known as the interrogation zone of the reader). It is noted that the interrogation zone of a reader is generally determined by the physical positioning and orientation of the reader relative to the tags, and the setting of various parameters (e.g., the transmit power) employed by the reader during the interrogation sequence.

During the typical interrogation sequence described above, the reader is tuned to detect changes in the small signals reflected from the antennae of the passive tags, or to receive the responses generated and transmitted by the active tags.

In preferred forms, the invention provides a mobile floor cleaning device that transmits a radio frequency (“RF”) signal and that has the ability to receive digital RF signals back from passive RFID tags. Intelligent, passive (no-power) RFID tags intercept the mobile cleaning device's RF signal and use the RF signal to power the RFID tag and then transmit an intelligent-digital RF signal back to the mobile cleaning device, informing the cleaning device of the presence of the RFID tag and what kind of RFID tag. The cleaning device has a controller with a processor having a software algorithm to interpret the digital data. A map may be defined by the controller or generated remotely and/or acquired, for example via a remote map server.

The RFID tag is preferably of the passive type, meaning that it does not transmit a signal on its own absent external stimulation. The RFID tag may thus only transmit a signal to the mobile floor cleaning device when the cleaning device is sufficiently near the tag and the cleaning device's RF energy has intercepted the tag.

In one form, the method of powering the RFID tags is by induction coupling, although other techniques such as propagating electromagnetic waves can be used. The RF signal from the RFID tag is a carrier signal that is transmitting an intelligent digital signal.

By way of background, in order to determine the position of a cleaning machine within a facility or site, a detailed map of the facility must be created. In known autonomous machine deployment approaches, mapping has been included a dedicated mapping device and reference to detailed drawings of the facility.

To create a facility map, a dedicated mapping machine may be transported throughout the facility while taking position measurements and storing way points. This information can be transferred to a mapping application running on the mapping machine or a remote computer. From this information, a map is created. Following map creation, the map can be used in the navigation and location of the autonomous vehicle. One limitation of this approach is that the mapping of the facility is a skilled task and is typically infrequently performed at the facility. Because this task requires special skills and equipment and is performed infrequently, the possibility of errors is high. This task is also non-productive (from a contract cleaners perspective) and is time consuming.

A facility map can also be created with reference to detailed drawings of the facility. This has typically been a time-consuming, highly skilled task. Additionally, the drawings necessary for the task may not be available to the contract cleaners.

A system in accordance with the present invention utilizes conventional cleaning equipment during the mapping process whereby an RFID reader is transported within a field of dispersed RFID tags as the cleaning equipment traverses a facility. Aspects of a mapping system can be incorporated into a cleaning machine, preferably in a manner transparent to the cleaning machine operator. Information gathering can be performed simultaneously with a floor cleaning process. In this manner, the activity of floor cleaning can automatically create or update a map of the floor field during the cleaning process. Map data can be accumulated over several cleaning cycles to compensate for areas the operator may have missed during earlier cleaning sessions. The mapping function can be characterized as passive, and the machine operator may not be aware of the mapping process.

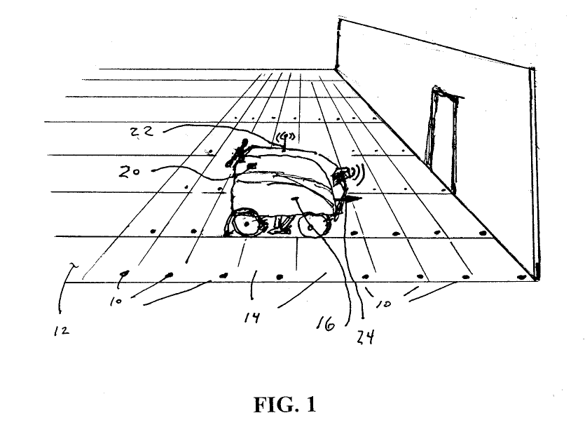

Referring to FIG. 1, RFID tags 10 can be dispersed within a floor field 12. In one example, tags 10 are incorporated into or secured to carpet tiles 14. In one embodiment, the tags 10 are placed in a regular pattern upon the floor field 12. During machine 16 operation, tag placement information can be determined via reader 24 and control system 20. Control system 20 may communicate via antenna 22 to a remote system for remote generation of a facility map. The information can be transferred using a data cell phone connection to a file site on the Internet.

In one example, machine 16 performs one or more floor cleaning operations of scrubbing, sweeping, vacuuming, buffing of the floor field 12. In other embodiments, machine 16 may perform other non-cleaning related operations. In this manner, a variety of different machines 16 can be utilized to implement the present invention.

Remote passive area mapping provides an application that utilizes information from a website and generates a usable map. Since the application is remote, and connected to the Internet, it can be utilized by a large number of machines and sites. These maps can be available for customer value, service value, as well as for autonomous navigation. Since the type of machine may be irrelevant, several machines could be used to map the same facility. This would decrease the time needed to complete the mapping process.

In another embodiment, hosted applications can utilize cleaning location data. Once the map is created, the cleaning machine can regularly report its position relative to the way points (RFID tags in this example). When this information is transferred to the hosted application, it can compare the collected way points with the points stored in the map. This enables a customer to log in and gather valuable information from the hosted application. For example, the customer may access areas which have been cleaned, how long it took to clean specific areas, what type of equipment was used, equipment parameters, etc.

In yet another embodiment, service delivery can be based on a passive map. For example, aside from basic cleaning information, other services could be delivered using the passive map. Delivery of consumables (pharmaceuticals, room service items, mail, etc.) within a hospital or hotel can be easily accomplished with an autonomous vehicle equipped with a reader capable of recognizing the way points. A communication system that allow the vehicle to receive a map and a navigation command from a hosted application would be particularly desirable. The facility map can be downloaded from the hosted application and destination points can be manually entered into the vehicle.

RFID tags 10 can be placed in many different ways. For example, RFID tags 10 can be integrated in labels or stickers. The RFID tags can be adhered in the environment. According to another example, RFID tags can be embedded in carpet or hardwood floors. In the example of FIG. 1, RFID tags 10 are provided in a regularly spaced grid-manner. In another example, RFID tags 10 may be randomly sprinkled or otherwise delivered across a floor field.

Once the RFID tags 10 are placed, their locations are determined during operation of cleaning machine 16. This can be done by using an external localization system with a tag reader. The system includes a tag reading tool that provides absolute measurements for the tag reader location. The tag reader reads the ID of the RFID tag and determines the RFID tag's location based on input from an external localization system or structure, e.g., knowledge of RFID placement pattern. Though not necessary, if the RFID tag has a re-writable memory, this location information can be included in the RFID tag's memory along with its ID number.

In one example, given the known placement of the RFID tags in an environment, and the shape of the scan volume of the tag reader, certain information about the location of the tag in the environment can be determined. This determination may be geometrical and can be extended with time information.

Referring again to FIG. 1, in one example scenario, assume that in an indoor environment, a regular grid of passive RFID tags has been placed on the floor. Further, assume that the locations of these tags are known to a desired precision. Each RFID tag has a unique ID. Given the known shape of the scanning volume, the location of the scanner/reader can be determined with respect to a coordinate system of which the positions of the passive RFID tags are known. The scanning volume and its intersection with the grid on which the RFID tags lie, as shown in FIG. 1, can yield orientation information to a certain accuracy.

The shape of the scanning volume can be used in localization. Similar to the surface shape of the RFID tags, the shape of the scan volume limits the amount of the localization information that can be recovered.

Referring now to the RFID tags, if the tags may have re-writeable memory, e.g., flash memory, their locations can be written into an on-board memory of the tag. This would allow a distributed storage of the localization data to make the localization system infinitely scalable.

Re-writable tag memory can also be used as a messaging medium. For example, in a multiple user application, one user can use the RFID tag for placing a message for another user to pick up. Various access control schemes can be imposed using the memory and location information.

Given that the positions of the RFID tags in the environment are known, the shape of the scanning volume is used to determine the location of the tag reader. The amount of localization information can be obtained from the tag reader will be determined by the shape of the scan volume as well as tags and their placements. Using this information, the position and orientation of the cleaning machine can be determined.

Localization in larger environments, such as within a factory or an office building, can be used in, for example, delivery of consumables, security and access control. Further uses may include data caching based on the location when storage and bandwidth limit the amount of data that can be stored.

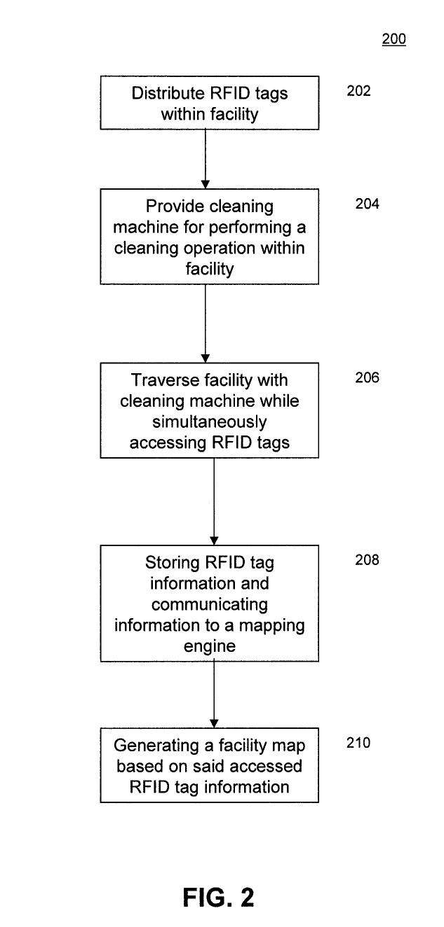

FIG. 2 illustrates a process 200 of mapping. At step 202, a plurality of tags are distributed throughout an region, such as a building, within which it is desired to identify the location of a cleaning machine. The tags may suitably be passive resonators. The RFID tags may be incorporated within carpet tiles having uniform size so as to define a grid-like distribution of the tags within the region. At step 204, a cleaning machine for performing a cleaning operation is provided within the region. At step 206, the cleaning machine traverses the region while performing a cleaning operation. Simultaneously with the cleaning operation, an RFID reader system accesses RFID tags proximate to the machine. At step 208, RFID tag information is stored and communicated to a mapping engine, which may be on the cleaning machine or remotely located. At step 210, a facility map is generated base on accessed RFID tag information. The mapping may be accomplished by recording signals associated with the plurality of RFID tags, identifying the locations and storing tag signals and their associated locations. Depending on the type of tag employed, this mapping may be done by storing codes and their locations or storing the various possible paths to reach each location. The mapping may suitably be repeated any time the locations to be identified have changed, for example when carpet tiles are added or modified, or when the tags have changed, for example when tags have failed and been replaced or moved within the floor field.

In one example of a cleaning machine utilizing a map generated as described above, software in a cleaning device's controller determines what action the cleaning device needs to take based on the data received from an RFID tag. For instance, if the controller receives data from the RFID tag indicating that the cleaning machine has come upon a particularly soiled region, the controller can execute a selected software routine adjusting the cleaner.

One or more RFID tags can be positioned along or adjacent to a floor surface to interact with a controller on a floor cleaner. In one form, the RFID tag can be positioned on the floor (e.g. on a carpet) and can transmit a signal causing the cleaner to clean for a greater amount of time adjacent the tag. In another form, the tag can be positioned on the floor and can transmit a signal causing the cleaner to spend less time (or even no time) adjacent the area of the floor adjacent that tag.

The tag can be designed to control or identify a specified radius around the tag (e.g. one meter), or can be designed to control a specified area adjacent and at one side of the tag. When used on a permanent basis the tag may be left in place, mounted on a surface, or incorporated into the area where it will be employed. For example, the tag could be attached or mounted permanently or removably to the underside of a carpet tile in order to hide the tag.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A portable floor cleaning machine performing a method for map generation to facilitate object localization within an environment comprising:
providing a plurality of tags having fixed positions within the environment, with each of said plurality of tags including a defined identification structure;
providing a reader upon a portable floor cleaning machine, said reader for detecting the tags and reading at least some information of the defined identification structures;
while performing a floor cleaning process with the portable floor cleaning machine, determining position information of the plurality of tags; and
defining a map of the environment based on said determining.

2. The method of claim 1 wherein the portable floor machine performs scrubbing, sweeping, buffing, polishing, burnishing or vacuuming.

3. The method of claim 1 wherein said defining a map utilizes an accumulation of data provided during multiple applications of said portable machine within the environment.

4. The method of claim 1 further comprising:
communicating the map to a remote location server.

5. The method of claim 1 further comprising:
downloading position information relating to the plurality of tags during machine operation.

6. The method of claim 5 wherein information related to a cleaning processes associated with a given area to be cleaned is stored within tags within or near said given area.

7. A portable floor cleaning machine comprising:
a portable chassis carrying a floor-engaging tool to perform a cleaning process upon a floor surface;
an RFID reader attached to said portable chassis for interrogating a plurality of RFID tags dispersed upon the floor surface; and
a mapping engine utilizing position information derived from said RFID reader to create a map of a facility as the portable chassis traverses the floor surface during the cleaning process.

8. The machine of claim 7 further comprising:
communication means for conveying the map to a remote location.

9. The machine of claim 8 wherein the remote location includes a mapping system accessible via the Internet during a subsequent cleaning process.

10. The machine of claim 7 wherein the map is periodically updated during subsequent cleaning sessions.

11. The machine of claim 7 wherein the map is updated when the mapping engine determines a change of RFID tag location as compared to an earlier map.

12. The machine of claim 7 wherein the mapping engine includes software stored on a controller of the machine.

13. A method of mapping a floor field containing RFID tags comprising:
providing a floor cleaning machine adapted to perform a cleaning process as the floor cleaning machine traverses the floor field;
simultaneously with said cleaning process, acquiring position data or identification data or both associated with a plurality of RFID tags on the floor field as each of said plurality of RFID tags comes into view of an RFID reader on said floor cleaning machine; and
utilizing said position data or identification data or both to define a map of said floor field, said map permitting localization of a machine traversing the floor field.

14. The method of claim 13 wherein said map defining is a passive process not under routine control of a operator of the floor cleaning machine.

15. The method of claim 13 wherein said map defining incorporates an accumulation of RFID tag data determined during multiple passes of said floor cleaning machine across the floor field.

16. The method of claim 13 further comprising:
locating a position of a second floor cleaning machine within the floor field based on said map.

17. The method of claim 13 further comprising:
updating the map during or after a subsequent floor cleaning process as new RFID tags within the floor field are detected.

18. The method of claim 13 further comprising:
updating the map during or after a subsequent floor cleaning process as one or more of the plurality of RFID are moved within the floor field.

19. The method of claim 13 further comprising:
communicating the map to a remote map server.

20. The method of claim 19 further comprising:
communicating map information from the remote server to a second floor cleaning machine operating within the floor field.
